(19) United States
(12) Patent Application Publication
(10) Pub. No.: US 2006/0040653 A1
(43) Pub. Date: Feb. 23, 2006

(54) Method and apparatus for determining an interference relationship between cells of a cellular communication system

(76) Inventors: Michael Ratford, Bath (GB); Simon Brusch, Faringdon (GB); Olatunde Williams, Tithe Barn Crescent (GB)

Correspondence Address: MOTOROLA, INC., 1303 EAST ALGONQUIN ROAD, IL01/3RD, SCHAUMBURG, IL, 60196, US

(21) Appl. No.: 10/533,279

(22) PCT Filed: Dec. 5, 2003
(86) PCT No.: PCT/EP03/50950

§ 371 Date: Apr. 28, 2005

(30) Foreign Application Priority Data
Dec. 18, 2002 (GB) 0229390.0

(51) Int. Cl. H04Q 7/20

(52) U.S. Cl. 455/423

(57) ABSTRACT

The invention relates to a system for determining an interference relationship between cells of a cellular communication system comprising at least a first cell and a second cell. A method comprises the step of dividing (205) an evaluation interval into a plurality of sub-intervals. For each sub interval, the method proceeds to determine (209) a sub-interval simultaneous occupancy related to the correlation between communication in the first and second cell. The sub-interval simultaneous occupancy is determined from an occupancy of each of the first cell and the second cell. A sub-interval potential interference is then determined (209) in response to the interference characteristics in each sub-interval. An interference relationship is subsequently determined from the sub-interval potential interferences and the sub-interval simultaneous occupancies. The interference relationship provides a measure of the impact of interference between the first and second cell suitable for frequency planning.

### FIELD OF THE INVENTION

The invention relates to a method and apparatus for determining an interference relationship between cells of a cellular communication system and in particular for determining an interference relationship suitable for frequency planning.

### BACKGROUND OF THE INVENTION

FIG. 1 illustrates the principle of a conventional cellular communication system 100 in accordance with prior art. A geographical region is divided into a number of cells 101, 103, 105, 107 each of which is served by base station 109, 111, 113, 115. The base stations are interconnected by a fixed network which can communicate data between the base stations 109, 111, 113, 115. A mobile station is served via a radio communication link by the base station of the cell within which the mobile station is situated. In the example of FIG. 1, mobile station 117 is served by base station 109 over radio link 119, mobile station 121 is served by base station 111 over radio link 123 and so on.

As a mobile station moves, it may move from the coverage of one base station to the coverage of another, i.e. from one cell to another. For example mobile station 125 is initially served by base station 113 over radio link 127. As it moves towards base station 115 it enters a region of overlapping coverage of the two base stations 113 and 115 and within this overlap region it changes to be supported by base station 115 over radio link 129. As the mobile station 125 moves further into cell 107, it continues to be supported by base station 115. This is known as a handover or handoff of a mobile station between cells.

A typical cellular communication system extends coverage over typically an entire country and comprises hundreds or even thousands of cells supporting thousands or even millions of mobile stations. Communication from a mobile station to a base station is known as uplink, and communication from a base station to a mobile station is known as downlink.

The fixed network interconnecting the base stations is operable to route data between any two base stations, thereby enabling a mobile station in a cell to communicate with a mobile station in any other cell. In addition the fixed network comprises gateway functions for interconnecting to external networks such as the Public Switched Telephone Network (PSTN), thereby allowing mobile stations to communicate with landline telephones and other communication terminals connected by a landline. Furthermore, the fixed network comprises much of the functionality required for managing a conventional cellular communication network including functionality for routing data, admission control, resource allocation, subscriber billing, mobile station authentication etc.

Currently, the most ubiquitous cellular communication system is the 2^{nd} generation communication system known as the Global System for Mobile communication (GSM). GSM uses a technology known as Time Division Multiple Access (TDMA) wherein user separation is achieved by dividing frequency carriers into 8 discrete time slots, which individually can be allocated to a user. A base station may be allocated a single carrier or a multiple of carriers. One carrier is used for a pilot signal which further contains broadcast information. This carrier is used by mobile stations for measuring of the signal level of transmissions from different base stations, and the obtained information is used for determining a suitable serving cell during initial access or handovers. Further description of the GSM TDMA communication system can be found in ‘The GSM System for Mobile Communications’ by Michel Mouly and Marie Bernadette Pautet, Bay Foreign Language Books, 1992, ISBN 2950719007.

Currently, 3^{rd} generation systems are being rolled out to further enhance the communication services provided to mobile users. The most widely adopted 3^{rd} generation communication systems are based on Code Division Multiple Access (CDMA) wherein user separation is obtained by allocating different spreading and scrambling codes to different users on the same carrier frequency. The transmissions are spread by multiplication with the allocated codes thereby causing the signal to be spread over a wide bandwidth. At the receiver, the codes are used to de-spread the received signal thereby regenerating the original signal. Each base station has a code dedicated for a pilot and broadcast signal, and as for GSM this is used for measurements of multiple cells in order to determine a serving cell. An example of a communication system using this principle is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

In order to optimise the capacity of a cellular communication system, it is important to minimise the impact of interference caused by or to other mobile stations. Thus, it is important to minimise the interference caused by the communication to or from a mobile station, and consequently it is important to use the lowest possible transmit power. As the required transmit power depends on the instantaneous propagation conditions, it is necessary to dynamically control transmit powers to closely match the conditions. For this purpose, the base stations and mobile stations operate power control loops, where the receiving end reports information on the receive quality back to the transmitting end, which in response adjusts it's transmit power. This ensures that the minimum transmit power necessary to ensure a given quality is used, and thus that interference caused by communication with each mobile station is minimised.

An important advantage of cellular communication systems is that, due to the radio signal attenuation with distance, the interference caused by communication within one cell is negligible in a cell sufficiently far removed, and therefore the resource can be reused in this cell. In GSM systems, carrier frequencies are therefore reused in other cells in accordance with a frequency plan. Frequency planning is one of the most important optimisation operations for a cellular communication system in order to maximise the communication capacity of the system. The frequency planning typically considers a vast number of parameters including propagation characteristics, traffic profiles and communication equipment capabilities.

Specifically, known frequency planning methods rely heavily on interference estimations between different cells. Automatic frequency planning methods have been developed wherein potential cross-interference and resulting carrier to interference ratios are determined for different possible frequency allocations. Typically, an interference level is determined as the interference caused to a communication between a mobile station and a base station in one cell by a potential communication between a mobile station and base station in a different cell. Conventionally, the interference is determined from propagation predictions based on calculated and measured propagation characteristics.

However, these interference values and carrier to interference ratios do not reflect the true impact on the performance of the communication system as they do not consider the relationship between the caused interference and the quality of service parameters provided by the communication system.

Accordingly, the frequency planning may become flawed, and sub-optimal frequency plans may be determined.

Hence, an improved system for determining an interference relationship between cells of a cellular communication system would be advantageous and in particular a system for determining an interference relationship suitable for frequency planning would be advantageous.

### SUMMARY OF THE INVENTION

Accordingly, the Invention seeks to mitigate, alleviate or eliminate one or more of the above mentioned disadvantages singly or in any combination.

According to a first aspect of the invention there is provided a method of determining an interference relationship between cells of a cellular communication system comprising at least a first cell and a second cell; the method comprising the step of: determining an interference relationship between the first cell and the second cell in response to a potential interference relationship between the first and the second cell and a simultaneous occupancy of the first cell and the second cell.

The Inventors of the current invention have realised that a more reliable measurement of the impact of interference on the performance of a cellular communication system can be achieved by considering a simultaneous occupancy between different cells. The simultaneous occupancy is a measure of the time correlation between communications of the first cell and second cell. It may specifically be determined as a probability of communications for the first and second cell being simultaneous and thus interfering with each other. Preferably, the simultaneous occupancy may be determined as the average probability of a resource unit in a first cell and the corresponding resource unit of the second cell being occupied at the same time.

The method allows for the interference relationship to reflect not only a level of potential interference but also the probability that such an interference will cause interference to a communicating unit. As such it provides a significantly more accurate reflection of the impact of the interference caused and thus a much improved interference relationship is provided. The improved interference relationship allows for much more accurate performance prediction of a cellular communication system. It allows for improved frequency planning and may accordingly significantly increase the capacity of the communication system.

According to a feature of the invention, the method further comprises the steps of: dividing an evaluation interval into sub-intervals; for each sub-interval determining a sub-interval potential interference in response to the interference characteristics in each sub-interval; and determining the potential interference relationship for the evaluation interval in response to the sub-interval potential interferences.

An improved accuracy of the determined interference relationship may be achieved by the consideration of the conditions in individual sub-intervals. Division into sub-intervals is furthermore suitable for practical implementations and may allow for a simple and low complexity implementation. Determining sub-interval potential interference provides a suitable method for taking into account the variation in interference with time thereby improving the reliability and/or accuracy of the determined interference relationship.

According to another feature of the invention, the step of determining a simultaneous occupancy comprises the steps of: dividing an evaluation interval into sub-intervals; for each sub-interval, determining a sub-interval simultaneous occupancy by determining an occupancy of each of the first cell and the second cell; and determining the simultaneous occupancy for the evaluation interval in response to the sub-interval simultaneous occupancies.

An improved accuracy of the determined interference relationship may be achieved by the consideration of the conditions in individual sub-intervals. Division into sub-intervals is furthermore suitable for practical implementations and may allow for a simple and low complexity implementation. Determining sub-interval simultaneous occupancy provides a suitable method for taking into account the variation of occupancy with time thereby improving the reliability and/or accuracy of the determined interference relationship.

According to another feature of the invention, the method further comprises the step of: dividing an evaluation interval into a plurality of sub-intervals; for each sub interval performing the steps of: determining a sub-interval simultaneous occupancy by determining an occupancy of each of the first cell and the second cell, determining a sub-interval potential interference in response to the interference characteristics in each sub-interval, and determining a sub-interval interference relationship in response to the sub-interval simultaneous occupancies and the sub-interval potential interferences; and wherein the interference relationship is determined in response to the sub-interval interference relationships.

An improved accuracy of the determined interference relationship may be achieved by the consideration of the conditions in individual sub-intervals. Division into sub-intervals is furthermore suitable for practical implementations and may allow for a simple and low complexity implementation. Determining sub-interval simultaneous occupancy and potential interference provides a suitable method for taking into account the variation in both occupancy and interference with time as well as taking into account the correlation between these. This enables an improved reliability and/or accuracy of the determined interference relationship.

According to another feature of the invention, the step of determining the simultaneous occupancy for the evaluation interval comprises determining the simultaneous occupancy as an average of the sub-interval simultaneous occupancies. An average simultaneous occupancy provides a suitable and advantageous measure of the simultaneous occupancy

According to another feature of the invention, the occupancy of at least one of the first cell and the second cell is determined from network statistics. This allows for the occupancy to be determined from statistics in the network. Typically, these statistics are also collected for other purposes and therefore the increased complexity is small. Hence, this allows for an implementation well suited for the characteristics of a cellular communication system.

According to another feature of the invention, the network statistics comprise a measurement report quantity characteristic. An occupancy may specifically be determined by determining how many measurement reports are received in a sub-interval. The measurement reports provide an indication of the traffic level and thus the occupancy of the cell. Hence, this allows for a low complexity implementation while providing accurate measures of the occupancy.

According to another feature of the invention, the potential interference relationship is determined in response to a measurement of a signal level in the second cell associated with a transmission in the first cell. A reliable potential interference relationship may be determined from measurements of transmissions in the other cell. Specifically, a signal level measurement of a broadcast signal in the first cell may provide a reliable indication of the potential interference that may be caused to communications in the second cell.

According to another feature of the invention, the potential interference relationship is associated with assignment of co-channel carriers in the first and the second cell. The method of determining an interference relationship may specifically relate to co-channel interference thereby providing a low complexity, reliable and accurate method of determining the impact of allocating co-channel carriers in the first and second cell.

According to another feature of the invention, the potential interference relationship is associated with assignment of adjacent channel carriers in the first and the second cell. The method of determining an interference relationship may specifically relate to adjacent channel interference thereby providing a low complexity, reliable and accurate method of determining the impact of allocating adjacent channel carriers in the first and second cell.

According to another feature of the invention, the potential interference relationship is in response to a ratio of communication units of the second cell for which an interference from the first cell will cause a quality level below a given threshold. Preferably the potential interference relationship is determined in relation to the ratio of communication units that cannot communicate with acceptable performance for the determined interference. This provides a very valuable measure of the degradation caused by the interference.

According to a second aspect of the invention, there is provided a method of frequency planning for a plurality of cells in a cellular communication system, the method comprising the steps of: determining the interference relationship for each combination of two cells of the plurality of cells in accordance with the method described above; for each combination of two cells determining a penalty associated with a corresponding frequency allocation in response to the interference relationship of that combination of two cells; and allocating carrier frequencies to the plurality of cells in response to the penalty values.

The method of determining an interference relationship may preferably be used for frequency planning. The method may be automated. Accurate and reliable frequency plans with improved performance may thus be developed for the cellular communication resulting in improved performance and capacity of the cellular communication system.

According to another feature of the invention, the frequency allocation is such that the sum of penalty values is minimised. This allows for frequency plans to be determined that minimise a given penalty criterion.

According to another feature of the invention, the cellular communication system is a GSM communication system. Hence, an improved method of determining an interference relationship between cells of a GSM communication system is provided allowing for improved frequency plans to be developed and accordingly for increased performance of the GSM communication system.

According to a third aspect of the invention, there is provided an apparatus for determining an interference relationship between cells of a cellular communication system comprising at least a first cell and a second cell; the apparatus comprising: means for determining an interference relationship between the first cell and the second cell in response to a potential interference relationship between the first and second cell and a simultaneous occupancy of the first and the second cell.

These and other aspects and advantages of the invention will be apparent from and elucidated with reference to the embodiment(s) described hereinafter.

### BRIEF DESCRIPTION OF THE DRAWINGS

An embodiment of the invention will be described, by way of example only, with reference to the drawings, in which

FIG. 1 is an illustration of a cellular communication system in accordance with the prior art;

FIG. 2 illustrates a flow chart of a method of determining an interference relationship in accordance with a preferred embodiment of the invention.

### DETAILED DESCRIPTION OF A PREFERRED EMBODIMENT OF THE INVENTION

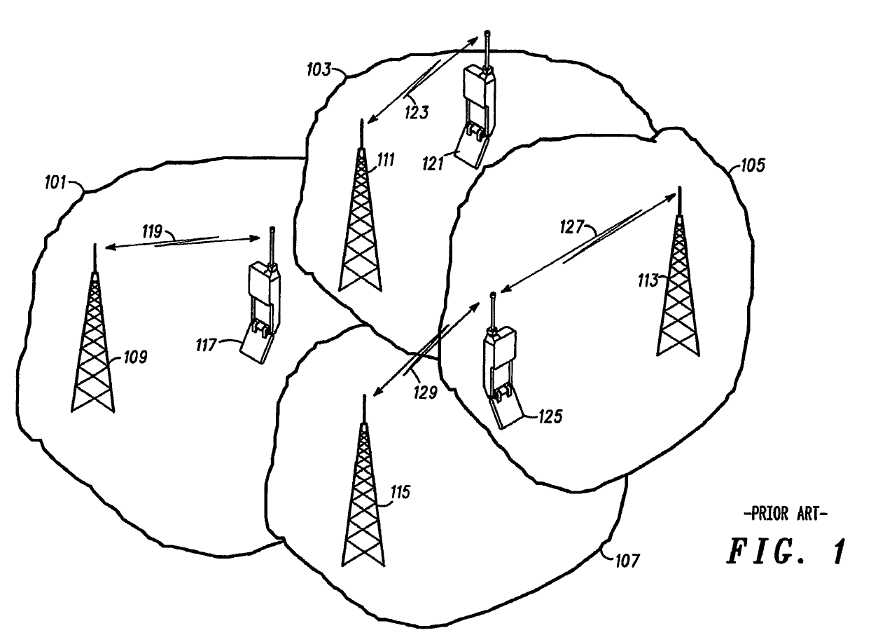

The following description focuses on an embodiment of the invention applicable to frequency planning for a GSM cellular communication system. However, it will be appreciated that the invention is not limited to this application but may be applied to many other applications and communication systems. Specifically, the invention will be described with reference to a communication systems such as that illustrated in FIG. 1.

A method of frequency planning for a GSM cellular communication system consist evaluating the potential interference that may be caused in one cell by transmission in another cell. Specifically, a carrier to interference ratio is determined for two cells under the assumption that they are allocated the same carriers.

Conventionally, the carrier to interference ratio has been derived from propagation predictions. Traditionally, the interference has been determined from transmit power assumptions and propagation predictions based on calculations or measurements. However carrier to interference ratios alone do not reflect the true impact of the interference caused by a frequency plan, as they do not take into account the amount of traffic suffering from interference or when that interference occurs. For example, one cell may cover a business park and a neighbouring cell may cover a football stadium. These cells may have high utilisation but the utilization will tend to be at different times. Hence, although transmissions of one cell may result in high levels of interference in the other cell, this will not have significant impact on the performance of the communication system as one of the two cells will always have a very low loading. Specifically, the cells may be allocated the same carrier frequency. However, a conventional frequency planning will prevent this allocation leading to a sub-optimal frequency plan.

In accordance with a preferred embodiment of the invention, a frequency planning method is provided wherein the frequency planning is in response to an interference relationship between cells. The interference relationship is determined in response to a simultaneous occupancy between the cells.

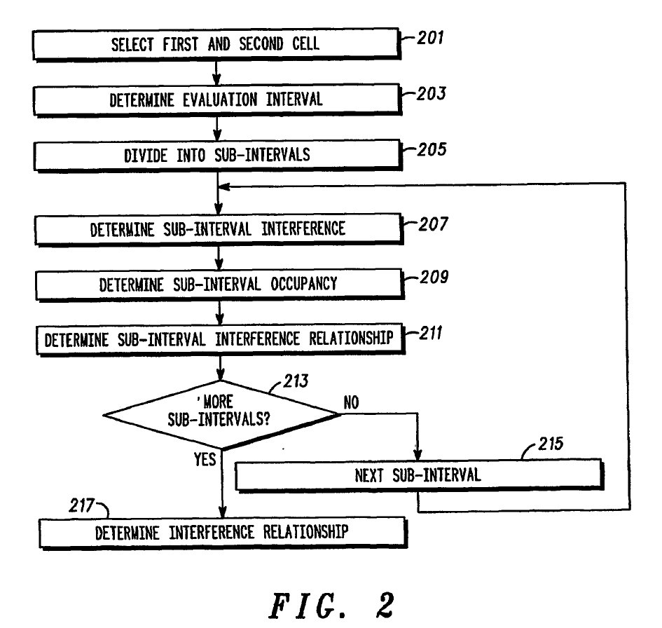

FIG. 2 illustrates a flow chart of a method of determining an interference relationship in accordance with a preferred embodiment of the invention.

In step 201 a first and second cell for which the interference relationship is to be determined is selected.

Step 201 is followed by step 203. In step 203, an evaluation interval is defined over which the interference relationship will be determined. The evaluation interval is preferably sufficiently long to allow for a statistically representative interference relationship to be determined. In the preferred embodiment, the evaluation interval preferably extends over several weeks thereby allowing the variations due to the daily and weekly traffic fluctuations to be included.

Step 203 is followed by step 205. In step 205 the evaluation interval is divided into a plurality of sub-intervals. The sub-intervals are preferably sufficiently small for the parameters used in the frequency planning to be considered relatively constant. In the preferred embodiment, each sub-interval may for example have a duration of one hour. It will be apparent, that the duration of the sub-interval will be a design parameter that can be selected by a person skilled in the art to meet the specific requirements and constraints of a specific embodiment.

Step 205 is followed by step 207. In step 207, a sub-interval potential interference is determined. In the preferred embodiment, the potential interference relates to the interference that may be received in the second cell by transmissions in the first cell.

In the preferred embodiment, the potential interference is determined in response to the measurement reports received from the communication units of the second cell. In a GSM communication system, the communication units make measurements of the received signal level of the broadcast carriers (BCCH carriers) of neighbouring base stations. Hence, if the first cell is included in the neighbour list for the second cell, the communication units of the second cell make measurements of the broadcast signal transmitted from the base station in the first cell. These measurements are reported back to the base stations and are in the preferred embodiment collected and used by the method of FIG. 2. Specifically, an average measured receive level of the signal from the first cell in the second cell is used as the potential interference. This will correspond to the average interference that would be received in the second cell, if the base station of the first cell transmitted continuously and the two cells were allocated the same carrier.

Hence, in the preferred embodiment, co-channel interference is specifically considered. Alternatively or additionally, adjacent interference associated with allocation of adjacent carriers to the first and second cell may be considered. The adjacent channel interference may specifically be determined similarly to the co-channel interference but further attenuated to reflect the reduction in interference in adjacent frequency bands.

In the preferred embodiment, the sub-interval potential interference is determined in response to the interference characteristics in each sub-interval, such that only the operating conditions of the sub-interval for which the sub-interval potential interference relates to is taken into account. Specifically, the sub-interval potential interference is determined in response only to measurement reports of the specific sub-interval.

Step 207 is followed by step 209. In step 209, a sub-interval simultaneous occupancy is determined for the sub-interval. In the preferred embodiment, the sub-interval simultaneous occupancy is determined from the individual occupancy of each of the first and second cell. Specifically, the ratio of utilised resource relative to the total available resource in the sub-interval is determined. For example, in GSM, a carrier comprises eight time slots. If the time slots of the first cell are used for an average of 30% of the duration of the sub-interval, the occupancy of the first cell is determined as 30%. The occupancy of the second cell is determined in the same way. A sub-interval simultaneous occupancy is then determined from the individual occupancies. Specifically, the sub-interval simultaneous occupancy Oₛ is given by:
Oₛ=O_{cell 1}·O_{cell 2}
where O_{cell 1} and O_{cell 2} are the individual occupancies of the first and second cell respectively.

Hence, the sub-interval simultaneous occupancy is a measure of the probability that communication on equivalent time slots in the first and second cell will occur. It is thus a measure of the probability that interference caused by transmission in one cell will affect a communication in the other cell.

The occupancy of the first and second cell is preferably determined from network statistics. Typically, in a cellular communication system, a large number of parameters are collected and used to determine statistics related to the operation of the cellular communication system. Specifically, traffic statistics are typically determined in an Operations and Maintenance Centre (OMC). These statistics typically include measures related to the loading of individual base stations. By relating these characteristics to each sub-interval, the occupancy in each sub-interval may be determined.

In one embodiment, the occupancy of a cell is determined from a measurement report quantity characteristic. Specifically, the number of measurement reports received by a base station in one sub-interval is counted. Measurement reports are reported at regular intervals by an active communication unit, and therefore the number of measurement reports directly correlates to a loading of the cell. As a specific example, a maximum measurement report count may be determined for a sub-interval. The maximum measurement report count corresponds to the number of measurement reports that are received if all time slots are continually used for the entire duration of the sub-interval. The occupancy of a cell may then be determined as the actual count in the sub-interval divided by the maximum measurement report count.

Step 209 is followed by step 211 wherein a sub-interval interference relationship is determined in response to the sub-interval simultaneous occupancies and the sub-interval potential interferences. For each sub-interval the potential interference and the simultaneous occupancy is used to determine a subinterval interference relationship. Preferably, the sub-interval interference relationship, Iₛ, is determined as
Iₛ=O_{cell 1}·O_{cell 2}·I₁₂
where I₁₂ is the sub-interval interference relationship of the sub-interval.

Step 211 is followed by step 213 wherein it is determined if more sub-intervals need to be processed. If so, the method continues in step 215 wherein the next sub-interval is selected. The method then repeats steps 207 to 213 for the new sub-interval.

When all sub-intervals have been processed, step 213 is followed by step 217. In step 217, an interference relationship between the first and second cell is determined in response to the sub-interval interference relationships. In the preferred embodiment, the sub-interval interference relationships are summed or averaged. Thus the interference relationship, I, is preferably given by:
I=ΣₛIₛ=ΣₛO_{cell 1,s}·O_{cell 2,s}·I_{12,s}
wherein the summation is over all sub-intervals of the evaluation interval (indexed by s).

Hence, an interference relationship is determined which reflects the impact of interference between two cells. The interference relationship takes into account the dynamic variations of both occupancy and interference as well as the correlation between these. Hence, the interference relationship provides an advantageous measure on which to base optimisation of the communication system and specifically frequency planning.

In another embodiment, the sub-interval potential interference is determined for each sub-interval as described above, whereas the simultaneous occupancy is determined for the whole evaluation interval. Specifically, the interference relationship may be determined as:
I=O_{cell 1}·O_{cell 2}ΣₛI_{12,s}

In another embodiment, the sub-interval simultaneous occupancy is determined for each sub-interval as described with respect to FIG. 2, whereas the sub-interval potential interference is determined for the whole evaluation interval. Specifically, the interference relationship may be determined as:
I=I₁₂·ΣₛO_{cell 1,s}·O_{cell 2,s}

Hence, the averaging and sub-intervals may be different for the simultaneous occupancy and the interference determinations. It is within the contemplation of the invention that an interference relationship may be determined for a given interval without dividing this into further sub-intervals.

In one embodiment, the potential interference relationship is in response to a ratio of communication units of the second cell for which an interference from the first cell will cause a quality level below a given threshold. In this embodiment, an interference level between the first and second cell is determined. The proportion of communication units for which this interference will cause an unacceptable performance is furthermore determined. For example, the carrier to interference ratio degradation caused by the interference may be calculated and compared to a threshold. Any communication unit having a resulting carrier to interference ratio below the threshold is considered to have an unacceptable quality.

In the preferred embodiment, the determined interference relationship is used in a method of frequency planning. In this embodiment, a plurality of cells for which a frequency plan is to be determined is selected. For each combination of two cells that may potentially interfere, an interference relationship is determined in accordance with the above described methods. In the preferred embodiment, an interference relationship is determined for a co-channel interference parameter and for an adjacent channel interference parameter for each combination. Hence, the interference relationship relates to the interference relationship that would result from an allocation of respectively the same or adjacent carriers to the first and second cell.

A penalty value is then determined for each of the combinations of two cells. The penalty value is determined in response to the interference relationship for the two cells. In the preferred embodiment, the penalty value may be a monotonically increasing function of the interference relationship or may specifically be identical to the interference relationship. The method then proceeds to allocate carrier frequencies such that a combined penalty value determined from the individual penalty values of the combinations is minimised. In the preferred embodiment, the combined penalty value is obtained as the sum of the individual penalty values for the cell combinations. The frequency allocation may specifically use a trial and error approach wherein different frequency allocations are tried randomly, and the frequency plan having the lowest combined penalty value selected.

The combined penalty value furthermore includes penalty values from the individual combinations related to both co-channel interference and adjacent channel interference. Hence, two cells allocated the same carrier frequency will contribute to the combined penalty value based on the co-channel interference relationship, and two cells allocated adjacent carrier frequencies will contribute to the combined penalty value based on the adjacent-channel interference relationship. Hence, the frequency plan will be optimized taking into account both the co-channel and the adjacent channel interference.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. In addition, singular references do not exclude a plurality. Thus references to “a”, “an”, “first”, “second” etc do not preclude a plurality.

1. A method of determining an interference relationship between cells of a cellular communication system comprising at least a first cell and a second cell; the method comprising the step of:
determining an interference relationship between the first cell and the second cell in response to a potential interference relationship between the first and the second cell and a simultaneous occupancy of the first cell and the second cell.

2. A method as claimed in claim 1 further comprising the steps of:
dividing an evaluation interval into sub-intervals;
for each sub-interval determining a sub-interval potential interference in response to the interference characteristics in each sub-interval; and
determining the potential interference relationship for the evaluation interval in response to the sub-interval potential interferences.

3. A method as claimed in claim 1 wherein the step of determining a simultaneous occupancy comprises the steps of:
dividing an evaluation interval into sub-intervals;
for each sub-interval, determining a sub-interval simultaneous occupancy by determining an occupancy of each of the first cell and the second cell; and
determining the simultaneous occupancy for the evaluation interval in response to the sub-interval simultaneous occupancies.

4. A method as claimed in claim 1 further comprising the steps of:
dividing an evaluation interval into a plurality of sub-intervals;
for each sub-interval performing the steps of:
determining a sub-interval simultaneous occupancy by determining an occupancy of each of the first cell and the second cell,
determining a sub-interval potential interference in response to the interference characteristics in each sub-interval, and
determining a sub-interval interference relationship in response to the sub-interval simultaneous occupancies and the sub-interval potential interferences; and
wherein the interference relationship is determined in response to the sub-interval interference relationships.

5. A method as claimed in claim 3 wherein the step of determining the simultaneous occupancy for the evaluation interval comprises determining the simultaneous occupancy as an average of the sub-interval simultaneous occupancies

6. A method as claimed in claim 3 wherein the occupancy of at least one of the first cell and the second cell is determined from network statistics.

7. A method as claimed in claim 6 wherein the network statistics comprise a measurement report quantity characteristic.

8. A method as claimed in claim 1 wherein the potential interference relationship is determined in response to a measurement of a signal level in the second cell associated with a transmission in the first cell.

9. A method as claimed in claim 1 wherein the potential interference relationship is associated with assignment of co-channel carriers in the first and the second cell.

10. A method as claimed in claim 1 wherein the potential interference relationship is associated with assignment of adjacent channel carriers in the first and the second cell.

11. A method as claimed in claim 1 wherein the potential interference relationship is in response to a ratio of communication units of the second cell for which an interference from the first cell will cause a quality level below a given threshold.

12. A method as claimed in claim 1, further comprising the step of frequency planning for the cells of the cellular communication system, frequency planning including the substeps of:
for the combinations of two cells determining a penalty associated with a corresponding frequency allocation in response to the interference relationship of that combination of two cells; and
allocating carrier frequencies to the plurality of cells in response to the penalty values.

13. A method as claimed in claim 12 wherein the frequency allocation is such that the sum of penalty values is minimised.

14. A method as claimed in claim 12 wherein the penalty values are associated with corresponding frequency allocations of co-channel frequencies.

15. A method planning as claimed in claim 12 wherein the penalty values are associated with the corresponding frequency allocations of adjacent channel frequencies.

16. A method according to claim 1 wherein the cellular communication system is a GSM communication system.

17-18. (canceled)

19. An apparatus for determining an interference relationship between cells of a cellular communication system comprising at least a first cell and a second cell; the apparatus comprising:
means for determining an interference relationship between the first cell and the second cell in response to a potential interference relationship between the first and second cell and a simultaneous occupancy of the first and the second cell.
